(19) United States
(12) Patent Application Publication
(10) Pub. No.: US 2008/0248278 A1
(43) Pub. Date: Oct. 9, 2008

(54) FIBER REINFORCED THERMOPLASTIC SHEETS WITH SURFACE COVERINGS AND METHODS OF MAKING

(75) Inventors: Scott M. Fisher, Delmar, NY (US); Vijay Mhetar, Slingerlands, NY (US)

Correspondence Address: CANTOR COLBURN LLP - SABIC (NORYL), 20 Church Street, 22nd Floor, Hartford, CT, 06103, US

(73) Assignee: GENERAL ELECTRIC COMPANY, Schenectady, NY (US)

(21) Appl. No.: 11/695,336

(22) Filed: Apr. 2, 2007

(51) Int. Cl. B32B 5/18

(52) U.S. Cl. 428/304.4; 252/609; 428/304.4

(57) ABSTRACT

A composite sheet material comprises a porous core layer adjacent to a skin layer. The porous core layer comprises a thermoplastic material and 20 to 80 weight percent (wt %) fibers based on a total weight of the porous core layer. The thermoplastic material comprises poly(arylene ether) and an additive comprising a flame retardant, a smoke emission retardant, a flame and smoke emission retardant or a combination of two or more of the foregoing retardants, wherein the additive is free of chlorine and bromine. The thermoplastic material may optionally comprise a viscosity modifier. The skin layer covers at least a portion of a surface of the porous core layer.

### BACKGROUND OF THE INVENTION

Disclosed herein is a porous fiber-reinforced thermoplastic polymer composite sheets that are free of halogen containing flame and smoke emission retardants and comprise poly(arylene ether) resin.

Porous fiber-reinforced thermoplastic composite sheets have been described in U.S. Pat. Nos. 4,978,489 and 4,670,331 and U.S. Patent Publication No. 2005/0215698. These composite sheets are used in numerous and varied applications in the product manufacturing industry because of the ease in molding the fiber reinforced thermoplastic sheets into articles. For example, known techniques such as thermo-stamping, compression molding, and thermoforming have been used to successfully form articles from fiber reinforced thermoplastic sheets.

Because of the varied applications, fiber-reinforced thermoplastic sheets are subjected to various performance tests. For example flame spread, smoke density, and toxicity performance of the fiber-reinforced thermoplastic sheets are important when the formed articles are used in environments that might be subjected to a flame event, such as a fire. Because of safety concerns, there is a need to improve the flame, smoke and toxicity performance of fiber reinforced thermoplastic sheet products. In addition to these performance requirements, increasing governmental regulations in certain countries necessitate the reduction or elimination of halogen containing flame and smoke emission retardants in such fiber-reinforced thermoplastic sheets.

### BRIEF DESCRIPTION OF THE INVENTION

Described herein is a composite sheet material comprising a porous core layer adjacent to a skin layer. The porous core layer comprises a thermoplastic material and 20 to 80 weight percent (wt %) fibers based on a total weight of the porous core layer. The thermoplastic material comprises poly(arylene ether) and an additive comprising a flame retardant, a smoke emission retardant, a flame and smoke emission retardant or a combination of two or more of the foregoing retardants, wherein the additive is free of chlorine and bromine. The thermoplastic material may optionally comprise a viscosity modifier. The skin layer covers at least a portion of a surface of the porous core layer.

In another aspect, a composite sheet material comprises a porous core layer having a surface. The porous core layer comprises discontinuous fibers bonded together with a thermoplastic material comprising poly(arylene ether). The porous core has a density of 0.2 grams per cubic centimeter (gm/cm³) to 1.5 gm/cm³. The composite sheet material further comprises a skin layer adjacent to and in physical contact with at least a portion of the surface of the porous core layer. The skin layer consists of a material having a limiting oxygen index greater than about 22, as measured in accordance with ISO 4589.

Also described herein is a method of manufacturing a composite sheet material. The method comprises laminating a skin layer to a surface of a porous core layer. The skin layer and the porous core layer are as described in the preceding paragraphs.

### BRIEF DESCRIPTION OF THE DRAWINGS

FIG. 1 is cross sectional illustration of an exemplary fiber reinforced thermoplastic sheet in accordance with an embodiment of the present invention.

FIG. 2 is cross sectional illustration of an exemplary fiber reinforced thermoplastic sheet in accordance with another embodiment of the present invention.

FIG. 3 is cross sectional illustration of an exemplary fiber reinforced thermoplastic sheet in accordance with another embodiment of the present invention.

### DETAILED DESCRIPTION OF THE INVENTION

In this specification and in the claims, which follow, reference will be made to a number of terms which shall be defined to have the following meanings. The singular forms “a,” “an,” and “the” include plural referents unless the context clearly dictates otherwise. Likewise, “one or more” and “at least one” are inclusive of one and may include a multiple number of the referred to components. “Optional” or “optionally” means that the subsequently described event or circumstance may or may not occur, and that the description includes instances where the event occurs and instances where it does not. The endpoints of all ranges reciting the same characteristic are independently combinable and inclusive of the recited endpoint.

Multi-layered porous fiber-reinforced composite sheets having characteristics of reduced flame spread, reduced smoke density, reduced heat release, and reduced gas emissions are described below in detail. The composite sheet comprises a retardant(s) that is free of chlorine and bromine. The retardants may be a single material or may be a combination of materials, e.g., flame retardants, smoke emission retardants, flame and smoke emission retardants or a combination of two of more retardants. In an exemplary embodiment, the multi-layered porous fiber-reinforced sheets include one or more porous core layers. At least a portion of a surface of the core layer is covered by a skin laminated to the core layer under heat and/or pressure with or without the use of an adhesive or a tie layer. The porous core layer comprises 20 weight percent to about 80 weight percent of fibers, based on the total weight of the porous core layer, and a thermoplastic material comprising poly(arylene ether) and a retardant. The thermoplastic material used in the core and the skin material are chosen, at least in part, to impart the desired reduction in flame spread, heat release, smoke density, and gaseous emissions of the composite sheet when exposed to a fire event. Handling, moldability and end use performance can be tailored by laminating two or more porous core layers together having different thermoplastic materials and/or different fibers. Further, skins can be laminated between core layers to affect performance characteristics.

The composite sheet material can have a four minute smoke density, Ds, of less than or equal to 200, or, more specifically, less than or equal to 100, or, more specifically, less than or equal to 50, when tested in accordance with ASTM E662. The four minute smoke density, Ds, is greater than or equal to 0.

The porous core layer is formed from a web made up of open cell structures formed by random crossing over of reinforcing fibers held together, at least in part, by a thermoplastic material, where the void content of the porous core layer is to 95%, or, more specifically 30 to 80% of the total volume of the porous core layer. In some embodiments, the porous core layer is made up of open cell structures formed by random crossing over of reinforcing fibers held together, at least in part, by a thermoplastic material, where 40 to 100% of the cell structures are open and allow the flow of air and gases through. The porous core layer can have a density of 0.2 to 1.5 gm/cm³, or, more specifically, 0.3 to 1.0 gm/cm³. The porous core layer can be formed using manufacturing processes such as a wet laid process, an air laid process, a dry blend process, a carding and needle process, and other processes that can be employed for making non-woven products. Combinations of such manufacturing processes are also useful. The web is heated above the glass transition temperature (Tg) of the thermoplastic material to substantially soften the thermoplastic material. When the thermoplastic material comprises two immiscible phases the web is heated above the Tg of the continuous phase. The heated web is passed through one or more consolidation devices, for example nip rollers, calendaring rolls, double belt laminators, indexing presses, multiple daylight presses, and other such devices used for lamination and consolidation of sheets and fabrics so that the plastic material can flow and wet out the fibers. The gap between the consolidating elements in the consolidation devices are set to a dimension less than that of the unconsolidated web and greater than that of the web if it were to be fully consolidated, thus allowing the web to expand and remain substantially permeable after passing through the rollers. In one embodiment, the gap is set to a dimension that is 5 to 10% greater than that of the web if it were to be fully consolidated. A fully consolidated web means a web that is fully compressed and substantially void free. A fully consolidated web would have less than 5% void content and have negligible open cell structure.

The porous core layer comprises about 20 to 80% by weight, or, more specifically, 35 to 55% by weight, based on the total weight of the porous core layer, of fibers and 20 to about 80% by weight, based on the total weight of the porous core layer. Useful fibers include metal, metalized inorganic, metalized synthetic, glass, graphite, carbon, ceramic, and fibers such as the aramid fibers sold under the trade names Kevlar and Nomex. Combinations of different types of fibers can also be used. In some embodiments a combination of glass fiber and carbon fiber or glass fiber and metal fiber is used. The porous core layer can be conductive due to the choice of fiber, the thermoplastic material or a combination thereof. The skin layer can also be conductive. The level of conductivity can be such that the composite sheet material is suitable for use in electrical shielding applications such as cell phone frequencies and wireless computer networks. In some embodiments the fiber has a tensile modulus greater than or equal to 10,000 Mega Pascals at room temperature and pressure.

In some embodiments all or a portion of the fiber used in the web may be optical fiber. This optical fiber can be random or specifically oriented to provide light transport from the edge of the sheet material to the optical fiber ends within the web. Optionally one end of the fiber may be specifically aligned along the edge of the manufactured sheet to gather light from a LED or other light source and distribute it into the web spacially. Optionally the optical fiber may be limited to the surface of the material as a covering.

The individual reinforcing fibers have an average length of 7 to 200 millimeters (mm), or, more specifically, 10 to 50 mm. In one embodiment, glass fibers are used and the glass fibers have an average diameter of 7 to 22 micrometers, or, more specifically, 10 to 16 micrometers.

The thermoplastic materials used in making the porous core layer can be in the form of particulates and short fibers which can enhance the cohesion of the web structure during manufacture. Bonding is effected by utilizing the thermal characteristics of the plastic materials within the web structure. The web structure is heated sufficiently to cause the thermoplastic material to fuse at its surfaces to adjacent particles and fibers.

The thermoplastic material of the porous core layer comprises a poly(arylene ether). The thermoplastic material has a low-shear viscosity as measured at 290° C. of less than 6,000 Pa-s according to the protocol of ASTM D4440 at a shear rate of 1.0 l/sec with a plate diameter of 2 centimeters (cm) and a gap width of 2 mm at 1.0 l/s frequency and a flat plate geometry. The poly(arylene ether) can exhibit less than a 100% increase, preferably less that 50% increase, in weight average molecular weight (Mw) after a 10 minute exposure to air at 300° C. In addition to the poly(arylene ether), the thermoplastic material may optionally comprise a viscosity modifier.

Poly(arylene ether) comprises repeating structural units of formula (I)

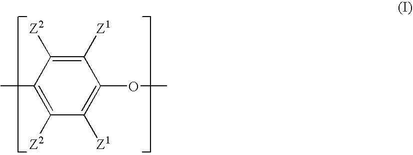

wherein for each structural unit, each Z¹ is independently a C₁-C₁₂ hydrocarbylthio, C₁-C₁₂ hydrocarbyloxy, or an unsubstituted or substituted C₁-C₁₂ hydrocarbyl with the proviso that the hydrocarbyl group is not a tertiary hydrocarbyl; and each Z² is independently hydrogen, C₁-C₁₂ hydrocarbylthio, C₁-C₁₂ hydrocarbyloxy or unsubstituted or substituted C₁-C₁₂ hydrocarbyl with the proviso that the hydrocarbyl group is not a tertiary hydrocarbyl.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as “substituted”, it can contain heteroatoms over and above the carbon and hydrogen members of the substituent residue. Thus, when specifically described as substituted, the hydrocarbyl residue can also contain nitro groups, cyano groups, carbonyl groups, carboxylic acid groups, ester groups, amino groups, amide groups, sulfonyl groups, sulfoxyl groups, sulfonamide groups, sulfamoyl groups, hydroxyl groups, alkoxyl groups, or the like, and it can contain heteroatoms within the backbone of the hydrocarbyl residue.

The poly(arylene ether) can comprise molecules having aminoalkyl-containing end group(s), typically located in an ortho position to the hydroxy group. Also frequently present are tetramethyl diphenylquinone (TMDQ) end groups, typically obtained from reaction mixtures in which tetramethyl diphenylquinone by-product is present.

The poly(arylene ether) can be in the form of a homopolymer; a copolymer; a graft copolymer; an ionomer; or a block copolymer; as well as combinations comprising at least one of the foregoing. Poly(arylene ether) includes polyphenylene ether comprising 2,6-dimethyl-1,4-phenylene ether units optionally in combination with 2,3,6-trimethyl-1,4-phenylene ether units.

The poly(arylene ether) can be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

In some embodiments, the poly(arylene ether) comprises a capped poly(arylene ether). The terminal hydroxy groups may be capped with a capping agent via an acylation reaction, for example. The capping agent chosen is preferably one that results in a less reactive poly(arylene ether) thereby reducing or preventing crosslinking of the polymer chains and the formation of gels or black specks during processing at elevated temperatures. Suitable capping agents include, for example, esters of salicylic acid, anthranilic acid, or a substituted derivative thereof, and the like; esters of salicylic acid, and especially salicylic carbonate and linear polysalicylates, are preferred. As used herein, the term “ester of salicylic acid” includes compounds in which the carboxy group, the hydroxy group, or both have been esterified. Suitable salicylates include, for example, aryl salicylates such as phenyl salicylate, acetylsalicylic acid, salicylic carbonate, and polysalicylates, including both linear polysalicylates and cyclic compounds such as disalicylide and trisalicylide. In one embodiment the capping agents are selected from salicylic carbonate and the polysalicylates, especially linear polysalicylates, and combinations comprising one of the foregoing. Exemplary capped poly(arylene ether) and their preparation are described in U.S. Pat. Nos. 4,760,118 to White et al. and 6,306,978 to Braat et al.

Capping poly(arylene ether) with polysalicylate is also believed to reduce the amount of aminoalkyl terminated groups present in the poly(arylene ether) chain. The aminoalkyl groups are the result of oxidative coupling reactions that employ amines in the process to produce the poly(arylene ether). The aminoalkyl group, ortho to the terminal hydroxy group of the poly(arylene ether), can be susceptible to decomposition at high temperatures. The decomposition is believed to result in the regeneration of primary or secondary amine and the production of a quinone methide end group, which may in turn generate a 2,6-dialkyl-1-hydroxyphenyl end group. Capping of poly(arylene ether) containing aminoalkyl groups with polysalicylate is believed to remove such amino groups to result in a capped terminal hydroxy group of the polymer chain and the formation of 2-hydroxy-N,N-alkylbenzamine (salicylamide). The removal of the amino group and the capping provides a poly(arylene ether) that is more stable to high temperatures, thereby resulting in fewer degradative products during processing of the poly(arylene ether).

The poly(arylene ether) can have a number average molecular weight of 3,000 to 40,000 grams per mole (g/mol) and a weight average molecular weight of 5,000 to 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) or combination of poly(arylene ether)s has an initial intrinsic viscosity greater than or equal to 0.25 dl/g, as measured in chloroform at 25° C. Initial intrinsic viscosity is defined as the intrinsic viscosity of the poly(arylene ether) prior to melt mixing with the other components of the composition and final intrinsic viscosity is defined as the intrinsic viscosity of the poly(arylene ether) after melt mixing with the other components of the composition. As understood by one of ordinary skill in the art the intrinsic viscosity of the poly(arylene ether) may be up to 30% higher after melt mixing. The percentage of increase can be calculated by (final intrinsic viscosity initial intrinsic viscosity)/initial intrinsic viscosity. Determining an exact ratio, when two initial intrinsic viscosities are used, will depend somewhat on the exact intrinsic viscosities of the poly(arylene ether) used and the ultimate physical properties that are desired.

The poly(arylene ether) can have a low-shear viscosity of less 6,000 Pa-sec at 290° C., or, more specifically, less than or equal to 5,000 Pa-sec at 290° C., or, even more specifically, less than or equal to 4,000 Pa-sec at 290° C., when measured using ASTM D4440 with plate diameter of 2 centimeters (cm) and a gap width of 2 mm at 1.0 l/s frequency and flat plate geometry.

In some embodiments, the poly(arylene ether) is a mixture of a first higher intrinsic viscosity poly(arylene ether), e.g., with an initial intrinsic viscosity of greater than or equal to 0.30 dl/g, with a second lower intrinsic viscosity poly(arylene ether), e.g., with an initial intrinsic viscosity of less than or equal to 0.25 dl/g. Suitable second lower intrinsic viscosity poly(arylene ether) include those having an initial intrinsic viscosity of less than 0.20 dl/g, or, more specifically, less than 0.15 dl/g. The amount and intrinsic viscosity of the second lower intrinsic viscosity poly(arylene ether) can be adjusted such that the resultant thermoplastic composition has a low-shear viscosity less than 6,000 Pa-sec at 290° C., or, more specifically, less than or equal to 5,000 Pa-sec at 290° C., or, even more specifically, less than or equal to 4,000 Pa-sec at 290° C., when measured using ASTM D4440 with plate diameter of 2 centimeters (cm) and a gap width of 2 mm at 1.0 l/s frequency and flat plate geometry.

The thermoplastic material comprises the poly(arylene ether) in an amount of 20 to 100 weight percent (wt %), or, more specifically, 50 to 95 wt % with respect to the total weight of the thermoplastic material.

In various embodiments, the thermoplastic material, in addition to the poly(arylene ether), may optionally comprise a viscosity modifier such as an alkenyl aromatic polymer (e.g., polystyrene and HIPS), polyamide, polyester, polyolefin, or a combination of two or more of the foregoing viscosity modifiers.

Alkenyl aromatic polymers include polymers prepared by methods known in the art including bulk, suspension, and emulsion polymerization, which contain at least 25% by weight of structural units derived from an alkenyl aromatic monomer of the formula (II)

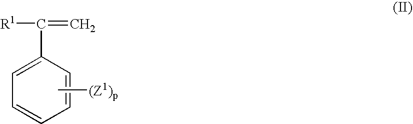

wherein R¹ is hydrogen, C₁-C₈ alkyl or halogen; Z¹ is defined as above; and p is 0 to 5. Exemplary alkenyl aromatic monomers include styrene, chlorostyrene, and vinyltoluene. The poly(alkenyl aromatic) resins include homopolymers of an alkenyl aromatic monomer; random copolymers of an alkenyl aromatic monomer, such as styrene, with one or more different monomers such as acrylonitrile, butadiene, alpha-methylstyrene, ethylvinylbenzene, divinylbenzene and maleic anhydride; and rubber-modified poly(alkenyl aromatic) resins comprising blends and/or grafts of a rubber modifier and a homopolymer of an alkenyl aromatic monomer (as described above), wherein the rubber modifier may be a polymerization product of at least one C₄-C₁₀ nonaromatic diene monomer, such as butadiene or isoprene, and wherein the rubber-modified poly(alkenyl aromatic) resin comprises about 98 to about 70 weight percent of the homopolymer of an alkenyl aromatic monomer and about 2 to about 30 weight percent of the rubber modifier, preferably about 88 to about 94 weight percent of the homopolymer of an alkenyl aromatic monomer and about 6 to about 12 weight percent of the rubber modifier.

The stereoregularity of the alkenyl aromatic polymers may be atactic or syndiotactic. Alkenyl aromatic polymers further include the rubber-modified polystyrenes, also known as high-impact polystyrenes or HIPS, comprising about 88 to about 94 weight percent polystyrene and about 6 to about 12 weight percent polybutadiene. These rubber-modified polystyrenes are commercially available as, for example, GEH 1897 from GE Plastics, and BA 5350 from Chevron.

When present, the composition may comprise the alkenyl aromatic polymer in an amount of 5 to 60 weight percent, or, more specifically, 10 to 50 weight percent, based on the total weight of the thermoplastic material. When employing a rubber-modified alkenyl aromatic polymer a sufficient amount of anti-oxidant should also be employed to prevent oxidation of the rubber modifier. The amount and specific type of the alkenyl aromatic polymer can be adjusted such that the resultant thermoplastic composition has a low-shear viscosity less than 6,000 Pa-sec at 290° C., or, more specifically, less than or equal to 5,000 Pa-sec at 290° C., or, even more specifically, less than or equal to 4,000 Pa-sec at 290° C., when measured using ASTM 4440 with plate diameter of 2 cm and gap width of 2 mm at 1.0 l/s frequency.

As used herein, polyamide resins, also known as nylons, are characterized by the presence of an amide group (—C(O)NH—), and are well known and broadly described in U.S. Pat. No. 4,970,272. Exemplary polyamide resins include, but are not limited to, nylon-6; nylon-6,6, nylon-4, nylon-4,6, nylon-12, nylon-6,10, nylon-6,9, nylon-6,12, amorphous polyamide resins, nylon-9T, nylon-6/6T, and nylon 6,6/6T with triamine contents below 0.5 weight percent; and combinations of two or more of the foregoing polyamides. In one embodiment, the polyamide resin comprises nylon-6 and nylon-6,6. In one embodiment the polyamide resin or combination of polyamide resins has a melting point (Tm) greater than or equal to 171° C. When the polyamide comprises a super tough polyamide, i.e. a rubber-toughed polyamide, the composition may or may not contain a separate impact modifier.

Polyamide resins may be obtained by a number of well known processes such as those described in U.S. Pat. Nos. 2,071,250; 2,071,251; 2,130,523; 2,130,948; 2,241,322; 2,312,966; and 2,512,606. Polyamide resins are commercially available from a wide variety of sources.

Polyamide resins having an intrinsic viscosity of up to 400 milliliters per gram (ml/g) can be used, or, more specifically, having a viscosity of 90 to 350 ml/g, or, even more specifically, having a viscosity of 110 to 240 ml/g, as measured in a 0.5 wt % solution in 96 wt % sulfuric acid in accordance with ISO 307.

The polyamide may have a relative viscosity of up to 6, or, more specifically, a relative viscosity of 1.89 to 5.43, or, even more specifically, a relative viscosity of 2.16 to 3.93. Relative viscosity is determined according to DIN 53727 in a 1 wt % solution in 96 wt % sulfuric acid.

In one embodiment, the polyamide resin used to make the thermoplastic composition comprises a polyamide having an amine end group concentration greater than or equal to 35 microequivalents amine end group per gram of polyamide (μeq/g) as determined by titration with HCl. Within this range, the amine end group concentration may be greater than or equal to 40 μeq/g, or, more specifically, greater than or equal to 45 μeq/g. Amine end group content may be determined by dissolving the polyamide in a suitable solvent, optionally with heat. The polyamide solution is titrated with 0.01 Normal hydrochloric acid (HCl) solution using a suitable indication method. The amount of amine end groups is calculated based the volume of HCl solution added to the sample, the volume of HCl used for the blank, the molarity of the HCl solution and the weight of the polyamide sample.

The polyamide can be present in the thermoplastic material in an amount of 5 to 85 weight percent, or, more specifically, 20 to 60 weight percent, or, even more specifically 30 to 50 weight percent, based on the total weight of the thermoplastic material. In some embodiments, the thermoplastic material comprises polyamide in an amount sufficient to have the polyamide form a continuous phase wherein the poly(arylene ether) is a dispersed phase.

The amount and specific type of the polyamide can be adjusted such that the resultant thermoplastic composition has a low-shear viscosity less than 6,000 Pa-sec at its processing temperature, typically 270 to 330° C., or, more specifically, 280 to 330° C., depending on the melting point of the polyamide. For example, the low shear viscosity can be less than 6,000 Pa-sec at 290° C., or, more specifically, less than or equal to 5,000 Pa-sec at 290° C., or, even more specifically, less than or equal to 4,000 Pa-sec at 290° C., when measured using ASTM 4440 with plate diameter of 2 cm and gap width of 2 mm at 1.0 l/s frequency and flat plate geometry.

Polyesters include those comprising structural units of the formula (III):

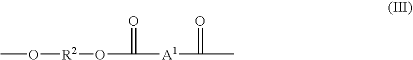

wherein each R² is independently a divalent aliphatic, alicyclic or aromatic hydrocarbon radical, or mixtures thereof and each A¹ is independently a divalent aliphatic, alicyclic or aromatic radical, or mixtures thereof. Examples of suitable polyesters comprising the structure of formula (III) are poly(allylene dicarboxylate)s, liquid crystalline polyesters, polyarylates, and polyester copolymers such as copolyestercarbonates and polyesteramides. Also included are polyesters that have been treated with relatively low levels of diepoxy or multi-epoxy compounds. It is also possible to use branched polyesters in which a branching agent, for example, a glycol having three or more hydroxyl groups or a trifunctional or multifunctional carboxylic acid has been incorporated. Treatment of the polyester with a trifunctional or multifunctional epoxy compound, for example, triglycidyl isocyanurate can also be used to make branched polyester. Furthermore, it is sometimes desirable to have various concentrations of acid and hydroxyl endgroups on the polyester, depending on the ultimate end-use of the composition.

The polyester may comprise nucleophilic groups such as, for example, carboxylic acid groups. In some instances, it is desirable to reduce the number of acid endgroups, typically to less than 30 micro equivalents per gram of polyester, with the use of acid reactive species. In other instances, it is desirable that the polyester has a relatively high carboxylic end group concentration, e.g., 5 to 250 micro equivalents per gram of polyester or, more specifically, 20 to 70 micro equivalents per gram of polyester.

In one embodiment, the R² radical in formula (III) is a C₂₋₁₀ alkylene radical, a C₆₋₁₀ alicyclic radical, or a C₆₋₂₀ aromatic radical in which the alkylene groups contain 2-6 and most often 2 or 4 carbon atoms. The A¹ radical in formula (III) is most often p- or m-phenylene or a mixture thereof. This class of polyesters includes the poly(alkylene terephthalates), the poly(alkylene naphthalates) and the polyarylates. Exemplary poly(alkylene terephthalates), include, poly(ethylene terephthalate) (PET), poly(cyclohexanedimethanol terephthalate) (PCT), and poly(butylene terephthalate) (PBT). Exemplary poly(alkylene naphthalate)s include poly(butylene-2,6-naphthalate) (PBN) and poly(ethylene-2,6-naphthalate) (PEN). Other useful polyesters include poly(ethylene-co-cyclohexanedimethanol terephthalate) (PETG), polytrimethylene terephthalate (PTT), poly(dimethanol-1,4-cyclohexanedicarboxylate) (PCCD), and polyxylene terephthalate (PXT). Polyesters are known in the art as illustrated by the following U.S. Pat. Nos. 2,465,319, 2,720,502, 2,727,881, 2,822,348, 3,047,539, 3,671,487, 3,953,394, and 4,128,526.

Liquid crystalline polyesters having melting points less that 380° C. and comprising recurring units derived from aromatic diols, aliphatic or aromatic dicarboxylic acids, and aromatic hydroxy carboxylic acids are also useful. Examples of useful liquid crystalline polyesters include, but are not limited to, those described in U.S. Pat. Nos. 4,664,972 and 5,110,896. Mixtures of polyesters are also sometimes suitable.

The polyester can be present in the thermoplastic material in an amount of 10 to 85 weight percent, or, more specifically, 33 to 60 weight percent, or, even more specifically, 40 to 55 weight percent, based on the total weight of the thermoplastic composition. In some embodiments, the thermoplastic composition comprises polyester in a sufficient amount to have the polyester form a continuous phase wherein the poly(arylene ether) is a dispersed phase.

The amount and specific type of the polyester can be adjusted such that the resultant thermoplastic material has a low-shear viscosity less than 6,000 Pa-sec at its processing temperature, typically 270 to 330° C. depending on the melting point of the polyester, or, more specifically, less than or equal to 5,000 Pa-sec, or, even more specifically, less than or equal to 4,000 Pa-sec, when measured using ASTM 4440 with plate diameter of 2 cm and gap width of 2 mm at 1.0 l/s frequency and flat plate geometry. In some embodiments, the resultant thermoplastic material has a low-shear viscosity of less than 6,000 Pa-sec at 290° C., or, more specifically, less than or equal to 5,000 Pa-sec at 290° C., or, even more specifically, less than or equal to 4,000 Pa-sec at 290° C., when measured using ASTM 4440 with plate diameter of 2 cm and gap width of 2 mm at 1.0 l/s frequency and flat plate geometry.

Polyolefins are of the general structure: CₙH₂ₙ and include polyethylene, polypropylene and polyisobutylene. Exemplary homopolymers include polyethylene, LLDPE (linear low density polyethylene), HDPE (high density polyethylene), MDPE (medium density polyethylene), and isotatic polypropylene. Polyolefin resins of this general structure and methods for their preparation are well known in the art and are described for example in U.S. Pat. Nos. 2,933,480, 3,093,621, 3,211,709, 3,646,168, 3,790,519, 3,884,993, 3,894,999, 4,059,654, 4,166,055 and 4,584,334.

Copolymers of polyolefins may also be used such as copolymers of ethylene and alpha olefins like propylene, octene and 4-methylpentene-1 as well as copolymers of ethylene and one or more rubbers and copolymers of propylene and one or more rubbers. Copolymers of ethylene and C₃-C₁₀ monoolefins and non-conjugated dienes, herein referred to as EPDM copolymers, are also suitable. Examples of suitable C₃-C₁₀ monoolefins for EPDM copolymers include propylene, 1-butene, 2-butene, 1-pentene, 2-pentene, 1-hexene, 2-hexene and 3-hexene. Suitable dienes include 1,4 hexadiene and monocylic and polycyclic dienes. Mole ratios of ethylene to other C₃-C₁₀ monoolefin monomers can range from 95:5 to 5:95 with diene units being present in the amount of from 0.1 to 10 mol %. EPDM copolymers can be functionalized with an acyl group or electrophilic group for grafting onto the polyphenylene ether as disclosed in U.S. Pat. No. 5,258,455.

The thermoplastic composition may comprise a single homopolymer, a combination of homopolymers, a single copolymer, a combination of copolymers or a combination comprising a homopolymer and a copolymer.

In one embodiment the polyolefin is selected from the group consisting of polypropylene, high density polyethylene and combinations of polypropylene and high density polyethylene. The polyolefin can also be a polyoctenomer or a combination of polyolefins comprising a polyoctenomer. The polypropylene can be homopolypropylene or a polypropylene copolymer. Copolymers of polypropylene and rubber or block copolymers are sometimes referred to as impact modified polypropylene. Such copolymers are typically heterophasic and have sufficiently long sections of each component to have both amorphous and crystalline phases. Additionally the polypropylene may comprise a combination of homopolymer and copolymer, a combination of homopolymers having different melting temperatures, or a combination of homopolymers having different melt flow rates.

In one embodiment the polypropylene comprises a crystalline polypropylene such as isotactic polypropylene. Crystalline polypropylenes are defined as polypropylenes having a crystallinity content greater than or equal to 20%, or, more specifically, greater than or equal to 25%, or, even more specifically, greater than or equal to 30%. Crystallinity may be determined by differential scanning calorimetry (DSC).

In some embodiments the polypropylene has a melting temperature greater than or equal to 134° C., or, more specifically, greater than or equal to 140° C., or, even more specifically, greater than or equal to 145° C.

The polypropylene has a melt flow rate (MFR) greater than 0.4 grams per ten minutes and less than or equal to 15 grams per ten minutes (g/10 min). Within this range the melt flow rate may be greater than or equal to 0.6 g10 min. Also within this range the melt flow rate may be less than or equal to 40, or, more specifically, less than or equal to 35, or, more specifically, less than or equal to 30 g/10 min. Melt flow rate can be determined according to ASTM D1238 using either powdered or pelletized polypropylene, a load of 2.16 kilograms and a temperature of 230° C.

The high density polyethylene can be homo polyethylene or a polyethylene copolymer. Additionally the high density polyethylene may comprise a combination of homopolymer and copolymer, a combination of homopolymers having different melting temperatures, or a combination of homopolymers having a different melt flow rate and generally having a density of 0.941 to 0.965 g/cm³.

In some embodiments the high density polyethylene has a melting temperature greater than or equal to 124° C., or, more specifically, greater than or equal to 126° C., or, even more specifically, greater than or equal to 128° C.

The high density polyethylene has a melt flow rate (MFR) greater than or equal to 0.10 grams per 10 minutes and less than or equal to 40 grams per ten minutes (g/10 min). Within this range the melt flow rate may be greater than or equal to 1.0 g/10 min. Also within this range the melt flow rate may be less than or equal to 35, or, more specifically, less than or equal to 30 g/10 min. Melt flow rate can be determined according to ASTM D1238 using either powdered or pelletized polyethylene, a load of 2.16 kilograms and a temperature of 190° C.

The polyoctenylenes or polyoctenamers are manufactured by the ring-opening or ring-expanding polymerization of cyclooctene. See, for example, A. Draxler, Kautschuk+Gummi, Kunststoffe, pages 185 to 190 (1981). Polyoctenylenes with different proportions of cis and trans double bonds, as well as different J-values and resultant different molecular weights, can be obtained through methods known in the literature. The polyoctenylenes can have a viscosity value of 50 to 350 cubic centimeters per gram (cm³/g), or, more specifically, 80 to 160 cm³/g, determined in a 0.1% solution in toluene. In some embodiments 55 to 95%, or, more specifically, 75 to 85%, of its double bonds are in the trans-form Polyoctenylenes are commercially available from Degussa under the trademark VESTENAMER.

The amount and specific type of the polyolefin can be adjusted such that the resultant thermoplastic material has a low-shear viscosity less than 6,000 Pa-sec at its processing temperature, typically 250 to 280° C. depending on the melting point of the polyolefin, or, more specifically, less than or equal to 5,000 Pa-sec, or, even more specifically, less than or equal to 4,000 Pa-sec, when measured using ASTM 4440 with plate diameter of 2 cm and gap width of 2 mm at 1.0 l/s frequency and flat plate geometry. In some embodiments, the resultant thermoplastic composition material has a low-shear viscosity of less than or equal to 6,000 Pa-sec at 290° C., or, more specifically less than or equal to 5,000 Pa-sec at 290° C., or, even more specifically, less than or equal to 4,000 Pa-sec at 290° C., when measured using ASTM 4440 with plate diameter of 2 cm and gap width of 2 mm at 1.0 l/s frequency and flat plate geometry.

The thermoplastic compositions may further comprise a compatibilizing agent. The expression “compatibilizing agent” refers to compounds which interact with the poly(arylene ether) and a second polymer such as a viscosity modifier. This interaction may be chemical (e.g., grafting) and/or physical (e.g., affecting the surface characteristics of the dispersed phases). In either instance the resulting compatibilized composition appears to exhibit improved compatibility, particularly as evidenced by enhanced impact strength, mold knit line strength and/or elongation. As used herein, the expression “compatibilized blend” refers to those compositions which have been physically and/or chemically compatibilized as discussed above, as well as those compositions which are physically compatible without such agents. Specific compatibilizers include citric acid, maleic anhydride, fumaric acid, as well as reactive poly(arylene ether) obtained as reaction products between poly(arylene ether) and one of the foregoing, as well as various polymeric compatibilizers such as carboxylic acid and anhydride functionalized poly(arylene ether) and styrenic block copolymers, e.g., S-EB-S, S-EP, S-I-S, S-B-S and the like known in the art of polymer blends.

Additional suitable compatibilizing agents include epoxy compounds, and include, but are not limited to, copolymers comprising structural units having pendant epoxy groups. In some embodiments suitable polymeric compatibilizers comprise copolymers comprising structural units derived from at least one monomer comprising a pendant epoxy group and at least one olefinic monomer, wherein the content derived from monomer comprising a pendant epoxy group is greater than or equal to 6 wt %, or, more specifically, greater than or equal to 8 wt %, or, even more specifically greater than or equal to 10 wt %. Illustrative examples of suitable compatibilizers include, but are not limited to, copolymers of glycidyl methacrylate (GMA) with alkenes, copolymers of GMA with alkenes and acrylic esters, copolymers of GMA with alkenes and vinyl acetate. Suitable alkenes comprise ethylene, propylene, and mixtures comprising ethylene and propylene. Suitable acrylic esters comprise alkyl acrylate monomers, including, but not limited to, methyl acrylate, ethyl acrylate, propyl acrylate, butyl acrylate, and combinations of the foregoing alkyl acrylate monomers. When present, said acrylic ester may be used in an amount of 15 wt % to 35 wt % based on the total amount of monomer used in the copolymer. When present, vinyl acetate may be used in an amount of 4 wt % to 10 wt % based on the total amount of monomer used in the copolymer. Illustrative examples of suitable compatibilizers comprise ethylene-glycidyl acrylate copolymers, ethylene-glycidyl methacrylate copolymers, ethylene-glycidyl methacrylate-vinyl acetate copolymers, ethylene-glycidyl methacrylate-alkyl acrylate copolymers, ethylene-glycidyl methacrylate-methyl acrylate copolymers, ethylene-glycidyl methacrylate-ethyl acrylate copolymers, and ethylene-glycidyl methacrylate-butyl acrylate copolymers.

Suitable epoxy compatibilizing agents are available from commercial sources, including Sumitomo Chemical Co., Ltd. under the trademarks BONDFAST 2C (also known as IGETABOND 2C; which is a copolymer comprising structural units derived from 94 wt % ethylene, and 6 wt % glycidyl methacrylate); BONDFAST E (also known as IGETABOND E; which is a copolymer comprising structural units derived from 88 wt % ethylene, and 12 wt % glycidyl methacrylate); IGETABOND 2B, 7B, and 20B (which are copolymers comprising structural units derived from 83 wt % ethylene, 5 wt % vinyl acetate, and 12 wt % glycidyl methacrylate); IGETABOND 7M and 20M (which are copolymers comprising structural units derived from 64 wt % ethylene, 30 wt % methyl acrylate, and 6 wt % glycidyl methacrylate); and from Atofina under the trademark LOTADER 8840 (which is a copolymer comprising structural units derived from 92 wt % ethylene, and 8 wt % glycidyl methacrylate); and LOTADER 8900 (which is a copolymer comprising structural units derived from 67 wt % ethylene, 25 wt % methyl acrylate, and 8 wt % glycidyl methacrylate). Mixtures of the aforementioned compatibilizers may also be employed. In one embodiment the compatibilizer is substantially stable at the processing temperature of the composite sheet. Those of skill in the art are readily able to select the type and amount of compatibilizing agent based on particular combination of polymers desired in the thermoplastic composition.

In one embodiment, the thermoplastic material further comprises one or more additives to reduce the flammability, smoke emissions, or flammability and smoke emissions of the composite sheet material. Suitable additives include boric acid, siloxane fluids, siloxane gums, siloxane treated inorganic fillers, amino functional siloxane fluids, the general class of molybdenates, the general class of hydrated borates, aluminum hydrates, ammonium polyphosphates, the general class of stannates, the general classes of ferrocenes, silyl-substituted ferrocenes, organometallic iron, and organo-phosphates, low melting phosphate glass, intumescent additives, inorganic phosphates, e.g., BPO4, as well as combinations of these materials with each other or other materials. Preferably, the thermoplastic material containing poly(arylene ether) has a limited oxygen index (LOI) greater than about 22, as measured in accordance with ISO 4589 test method.

The flame and smoke emission retardants used in the thermoplastic compositions are free of chlorine and bromine. Free of chlorine and bromine means that the additives contain less that 5000 parts by weight per million parts by weight of additive (ppm), or, more specifically, less than 1000 ppm, or, even more specifically, less that 500 μm or, even more specifically, less that 100 ppm of total chlorine and bromine. If present, the chlorine and bromine are an impurity and not present as an intended component of the thermoplastic composition. Useful exemplary flame and/or smoke emission retardants include phosphinates, melamine (CAS No. 108-78-1), melamine cyanurate (CAS No. 37640-57-6), melamine phosphate (CAS No. 20208-95-1), melamine pyrophosphate (CAS No. 15541-60-3), melamine polyphosphate (CAS No. 218768-84-4), melam, melem, melon, zinc borate (CAS No. 1332-07-6), boric acid, boron phosphate, organopolysiloxanes, red phosphorous (CAS No. 7723-14-0), organophosphate esters, monoammonium phosphate (CAS No. 7722-76-1), diammonium phosphate (CAS No. 7783-28-0), alkyl phosphonates (CAS No. 78-38-6 and 78-40-0), metal dialkyl phosphinate, ammonium polyphosphates (CAS No. 68333-79-9), melamine borate (CAS No. 53587-44-3), low melting glasses and combinations of flame and smoke emission retardants containing two or more of the foregoing retardants.

Exemplary organophosphate ester flame and smoke emission retardants include, but are not limited to, phosphate esters comprising phenyl groups, substituted phenyl groups, or a combination of phenyl groups and substituted phenyl groups, bis-aryl phosphate esters based upon resorcinol such as, for example, resorcinol bis-diphenylphosphate, as well as those based upon bis-phenols such as, for example, bis-phenol A bis-diphenylphosphate. In one embodiment, the organophosphate ester is selected from tris(alkylphenyl)phosphate (for example, CAS No. 89492-23-9 or CAS No. 78-33-1), resorcinol bis-diphenylphosphate (for example, CAS No. 57583-54-7), bis-phenol A bis-diphenylphosphate (for example, CAS No. 181028-79-5), triphenyl phosphate (for example, CAS No. 115-86-6), tris(isopropylphenyl)phosphate (for example, CAS No. 68937-41-7) and mixtures of two or more of the foregoing organophosphate esters.

In one embodiment the organophosphate ester comprises a bis-aryl phosphate of Formula IV:

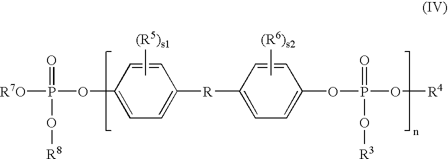

wherein R, R⁵ and R⁶ are independently at each occurrence an alkyl group having 1 to 5 carbons and R³, R⁴, R⁷, and R⁸ are independently an alkyl, aryl, arylalkyl or alkylaryl group having 1 to 10 carbons; n is an integer equal to 1 to 25; and s1 and s2 are independently an integer equal to 0 to 2. In some embodiments OR⁷, OR⁸, OR³ and OR⁴ are independently derived from phenol, a monoalkylphenol, a dialkylphenol or a trialkylphenol.

As readily appreciated by one of ordinary skill in the art, the bis-aryl phosphate is derived from a bisphenol. Exemplary bisphenols include 2,2-bis(4-hydroxyphenyl)propane (so-called bisphenol A), 2,2-bis(4-hydroxy-3-methylphenyl)propane, bis(4-hydroxyphenyl)methane, bis(4-hydroxy-3,5-dimethylphenyl)methane and 1,1-bis(4-hydroxyphenyl)ethane. In one embodiment, the bisphenol comprises bisphenol A.

Organophosphate esters can have differing molecular weights making the determination of the amount of different organophosphate esters used in the thermoplastic composition difficult. In one embodiment the amount of phosphorus, as the result of the organophosphate ester, is 0.8 weight percent to 1.2 weight percent with respect to the total weight of the composition.

In one embodiment, the thermoplastic composition comprises an organophosphate ester present in an amount of 5 to 18 weight percent (wt. %), with respect to the total weight of the composition. Within this range the amount of organophosphate ester can be greater than or equal to 7 wt. %, or more specifically, greater than or equal to 9 wt. %. Also within this range the amount of organophosphate ester can be less than or equal to 16 wt. %, or, more specifically, less than or equal to 14 wt. %.

In some embodiments, the thermoplastic composition may comprise a phosphinate. This class of materials is especially useful when the thermoplastic composition comprises a polyamide in addition to the poly(arylene ether). The phosphinate may comprise one or more phosphinates of formula V, VI, or VII

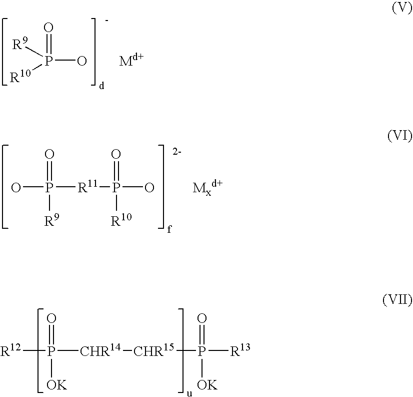

wherein R⁹ and R¹⁰ are independently C₁-C₆ alkyl, phenyl, or aryl; R¹¹ is independently C₁-C₁₀ alkylene, C₆-C₁₀ arylene, C₆-C₁₀ alkylarylene, or C₆-C₁₀ arylalkylene; M is calcium magnesium aluminum zinc or a combination comprising one or more of the foregoing; d is 2 or 3; f is 1 or 3; x is 1 or 2; each R¹² and R¹³ are independently a hydrogen group or a vinyl group of the formula CR⁷═CHR⁸; R¹⁴ and R¹⁵ are independently hydrogen, carboxyl, carboxylic acid derivative, C₁-C₁₀ alkyl, phenyl, benzyl, or an aromatic substituted with a C₁-C₈ alkyl; K is independently hydrogen or a l/r metal of valency r and u, the average number of monomer units, may have a value of 1 to 20.

Examples of R⁹ and R¹⁰ include, but are not limited to, methyl, ethyl n-propyl isopropyl, n-butyl, tert-butyl, n-pentyl, and phenyl. In one embodiment, R⁹ and R¹⁰ are ethyl. Examples of R¹¹ include, but are not limited to, methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylnapthylene, ethylnapthylene, tert-butylnaphthylene, phenylethylene, phenylpropylene, and phenylbutylene.

The mono- and diphosphinates (formulas V and VI, respectively) may be prepared by reacting the corresponding phosphinic acid with a metal oxide and/or metal hydroxide in an aqueous medium as taught in EP 0 699 708.

The polymeric phosphinates (formula VII) may be prepared by reacting hypophosphorous acid and or its alkali metal salt with an acetylene of formula (VIII)

R¹⁴—C≡C—R¹⁵ (VIII).

The resulting polymeric phosphinic acid or polymeric phosphinic acid salt is then reacted with a metal compound of groups IA, IIA, IIIA, IVA, VA, IIB, IVB, VIIB, VIIIB of the Periodic Table as taught in U.S. Patent Application No. 2003/0216533.

In one embodiment the phosphinate is in particulate form. The phosphinate particles may have a median particle diameter (D50) less than or equal to 40 micrometers, or, more specifically, a D50 less than or equal to 30 micrometers, or, even more specifically, a D50 less than or equal to 25 micrometers. Additionally, the phosphinate may be combined with a polymer, such as a poly(arylene ether), a polyolefin, and/or a polyamide to form a masterbatch. The phosphinate masterbatch comprises the phosphinate in an amount greater than is present in the thermoplastic composition. Employing a masterbatch for the addition of the phosphinate to the other components of the composition can facilitate addition and improve distribution of the phosphinate.

The thermoplastic material may optionally comprise an inorganic compound such as an oxygen compound of silicon, a magnesium compound, a metal carbonate of metals of the second main group of the periodic table, red phosphorus, a zinc compound, an aluminum compound or a composition comprising one or more of the foregoing. The oxygen compounds of silicon can be salts or esters of orthosilicic acid and condensation products thereof; silicates; zeolites; silicas; glass powders; glass-ceramic powders; ceramic powders; or combinations comprising one or more of the foregoing oxygen compound of silicon. The magnesium compounds can be magnesium hydroxide, hydrotalcites, magnesium carbonates or magnesium calcium carbonates or a combination comprising one or more of the foregoing magnesium compounds. The red phosphorus can be elemental red phosphorus or a preparation in which the surface of the phosphorus has been coated with low-molecular-weight liquid substances, such as silicone oil, paraffin oil or esters of phthalic acid or adipic acid, or with polymeric or oligomeric compounds, e.g., with phenolic resins or amino plastics, or else with polyurethanes. The zinc compounds can be zinc oxide, zinc stannate, zinc hydroxystannate, zinc phosphate, zinc borate, zinc sulfides or a composition comprising one of more of the foregoing zinc compounds. The aluminum compounds can be aluminum hydroxide, aluminum phosphate, or a combination thereof.

In one embodiment, the thermoplastic material comprises an inorganic compound comprising zinc borate. A particularly useful form of zinc borate has the formula 2 ZnO 3 B₂O₃ 3.5H₂O.

In some embodiments, the thermoplastic composition comprises boric acid. Boric acid refers to 3 compounds; orthoboric acid (also called boracic acid, H₃BO₃ or B₂O₃.3H₂O), metaboric acid (HBO₂ or B₂O₃.H₂O), and tetraboric acid (also called pyroboric, H₄B₄O₇ or B₂O₃.H₂O). Orthoboric acid dehydrates to form metaboric acid and tetraboric acid above 170° C. and 300° C., respectively. Orthoboric acid is derived from boric oxide in the form of white, triclinic crystals. It is poorly soluble in cold water but dissolves readily in hot water, in alcohol and glycerine. Metaboric acid is a white, cubic crystals. It is soluble in water slightly. Tetraboric acid is a white solid soluble in water. When tetraboric and metaboric acid are dissolved, it reverts to orthoboric acid. Zinc borate and boric acid are particularly useful, either alone or in combination with another flame retardant, to manufacture a composite sheet material having a four minute smoke density, Ds, of less than about 50 when tested in accordance with ASTM E662.

In some embodiments, the thermoplastic material comprises a polyorganosiloxane. Polyorganosiloxanes are compounds known per se. Their properties vary from a comparatively low viscous liquid to rubber-like polymers. Polyorganosiloxanes usually consist of a main chain of alternating silicon atoms and oxygen atoms, substituted with various groups at the silicon atom. The polyorganosiloxanes may have different structures: homopolymer, block copolymer, or random copolymer. Suitable polyorganosiloxanes are liquids in which the constituents at the silicon atoms mainly consist of alkyl groups, for example, methyl groups, or aryl groups, for example, phenyl groups, or a combination of the two. It is also possible that a part of the silicon atoms is bonded to a hydrogen atom Polyorganosiloxanes containing aryl constituents are often preferred due to their improved compatibility with poly(arylene ether) as compared to polyorganosiloxanes containing only alkyl constituents.

It is possible to use polyorganosiloxanes which comprise one or more constituents which are capable of reacting with a carboxyl group and/or an anine group. Examples of such groups are: amine groups, epoxy groups, oxazoline, ortho ester, and groups derived from carboxylic acids, e.g., anhydrides and esters.

In some embodiments, the thermoplastic material may comprise a low melting glass containing phosphate, usually in the form of P₂O₅. The glass further contains at least one of the following components: GO; G′₂O; Al₂O₃; B₂O₃; or SO₃. In the formula “GO”, G is at least one bivalent metal. Exemplary bivalent metals include Mg, Ca, Zn, Sn, and Ba. In some embodiments the low melting glass comprises zinc oxide, ZnO. In the formula “G′₂O”, G′ is at least one alkali metal, e.g., Li, Na, and K. The amount of the phosphorous component in the glass is usually 10 to 60 mole %, calculated as P₂O₅. In some embodiments, the level of phosphorous is 15 to 45 mole %.

The low melting glass may also comprise Al₂O₃ and/or SO₃. Examples of the some of the more specific, zinc-containing glass compositions are as follows: P₂O₅—ZnO-G′₂O; P₂O₅—ZnO—SO₃; and P₂O₅—ZnO—Al₂O₃. Additional metal oxides are also sometimes present in any of these glass compositions. Examples include oxides of one or more elements selected from the group consisting of Sr, Ti, Fe, Co, Ni, Cu, Zr, Mn, and Mo. The low melting glass can be free of heavy metal oxides like PbO and BaO.

The low-melting glass has a glass transition temperature (Tg) of 200 to 500° C. In some embodiments, the Tg is in the range of about 250° C. to about 400° C. (The Tg can be adjusted, in part, by varying the glass ingredients, which have different, individual melting points).

If the Tg of the glass is too high, the glass may remain relatively solid at elevated temperatures, i.e. the combustion temperatures for the compositions. It would therefore be difficult for the glass to melt and effectively form a protective coating on the thermoplastic resin. Conversely, if the Tg of the glass is too low, the glass may prematurely melt when the thermoplastic resin is subjected to flame or combustion-conditions. In that instance, the glass may provide flame retardance at lower temperatures, but may begin to flow excessively at higher temperatures, due to the viscosity decrease. Thus, the glass will not remain coated on the thermoplastic resin, and its beneficial effect on flame retardance and smoke suppression may be somewhat compromised. (However, in some instances, there may be some benefit to using glass with a Tg in the lower region of the ranges stated above, e.g., about 200° C. to about 300° C. Such a material might desirably melt while being extruded, and could result in a final material with other desirable properties, like abrasion resistance, dimensional tolerance, and low coefficient of thermal expansion (CTE). Those skilled in the art will be able to select the most appropriate Tg, based on a variety of factors.

The low-melting glass component could be used in a variety of forms; however, powder form is preferred in most situations. Usually, the powder has an average particle size no greater than about 10 micrometers. This size helps to ensure intimate contact with and dispersal through the thermoplastic material. It also permits rapid melting of the glass when the porous core layer is subjected to a fire event, thereby allowing for rapid formation of the protective glass film on the thermoplastic material. The average particle size is often in the range of 2 to 5 micrometers.

Usually, the low-melting glass is present in an amount of 0.05 to 25% by weight, or, more specifically, 0.5 to 10% by weight, or, even more specifically, 0.5 to 5% by weight, based on the weight of the thermoplastic material. When the thermoplastic material comprises greater than or equal to 90% by weight of poly(arylene ether) the amount of low melting glass can be 0.5 to 2% by weight, based on the total weight of the thermoplastic material.

The amount and specific type of the flame and smoke emission retardant can be adjusted such that the resultant thermoplastic material has a low-shear viscosity less than 6,000 Pa-sec at 290° C., or, more specifically, less than or equal to 5,000 Pa-sec at 290° C., or, even more specifically, less than or equal to 4,000 Pa-sec at 290° C., when measured using ASTM 4440 with a plate diameter of 2 cm and a gap width of 2 mm at 1.0 l/s frequency and flat plate geometry.

The thermoplastic resin may optionally contain an electrically conductive filler to alter the electrical properties of the composite sheet material. The optional electrically conductive filler may comprise electrically conductive carbon black, carbon nanotubes, carbon fibers, or a combination of two or more of the foregoing electrically conductive filler. Electrically conductive carbon blacks are commercially available and are sold under a variety of trade names, including but not limited to S.C.F. (Super Conductive Furnace), E.C.F. (Electric Conductive Furnace), Ketjen Black EC (available from Akzo Co., Ltd.) or acetylene black. In some embodiments the electrically conductive carbon black has an average particle size less than or equal to 200 nanometers (nm), or, more specifically, less than or equal to 100 nm, or, even more specifically, less than or equal to 50 nm. The electrically conductive carbon blacks may also have surface areas greater than 200 square meter per gram (m²/g), or, more specifically, greater than 400 m²/g, or, even more specifically, greater than 1000 m²/g. The electrically conductive carbon black may have a pore volume greater than or equal to 40 cubic centimeters per hundred grams (cm³/100 g), or, more specifically, greater than or equal to 100 cm³/100 g, or, even more specifically, greater than or equal to 150 cm³/100 g, as determined by dibutyl phthalate absorption.

Carbon nanotubes that can be used include single wall carbon nanotubes (SWNTs), multiwall carbon nanotubes (MWNTs), vapor grown carbon fibers (VGCF) and combinations comprising two or more of the foregoing. Particularly useful carbon nanotubes may be obtained from Hyperion Catalysis International.

The thermoplastic material can be prepared by a variety of methods involving intimate admixing of the materials with any additional additives desired in the formulation. Suitable procedures include solution blending and melt blending. Because of the availability of melt blending equipment in commercial polymer processing facilities, melt processing procedures are generally used. Examples of equipment used in such melt blending methods include: co-rotating and counter-rotating extruders, single screw extruders, disc-pack processors and various other types of extrusion equipment. In some instances, the melt blended material exits the extruder through small exit holes in a die and the resulting strands of molten material are cooled by passing the strands through a water bath. The cooled strands can be chopped into small pellets for grinding into an acceptable particulate form packaging and further handling. Alternatively an underwater pelletizer yielding pellets of having a longest linear dimension of less than or equal to 1.5 mm may also be used. In some instances, the melt blended material exits an extruder through small exit holes in a die and the resulting strands of molten material are drawn (elongated) to a diameter of less than 1.5 mm using any suitable means. The size and number of die holes as well as the heating and drawing arrangement are consistent with equipment and processes known in the art of thermoplastic processing. These strands are cooled (possibly by air or water) and cut to less than 500 mm in length. A melt spinneret compatible with known in the art melt fiber processing may also be employed.

All of the ingredients may be added initially to the processing system or else some components may be dry blended or melt blended with each other prior to combining with the remaining components. It is sometimes advantageous to introduce the liquid components into the melt mixing device through the use, for example, of a liquid injection system as is known in the compounding art. It is also sometimes advantageous to employ at least one vent port in each section between the feed ports to allow venting (either atmospheric or vacuum) of the melt. Those of ordinary skill in the art will be able to adjust blending times and temperatures, as well as component addition location and sequence, without undue additional experimentation.

In the manufacture of the porous core layer of the composite sheet, the thermoplastic material particles need not be excessively fine, but particles having an average size greater than 1.5 millimeters are unsatisfactory in that they do not flow sufficiently during the molding process to produce a sufficiently homogenous structure. The use of larger particles can result in a reduction in the flexural modulus of the material when consolidated. In one embodiment, the thermoplastic material average particle size is less than or equal to 1 millimeter. Typical average particle size specification limits include an average particle size of 600 micron±20 microns with a lower specification limit of 200 microns (70 mesh) and an upper limit of 1000 microns (18 mesh). In some embodiments less than 5 weight percent of the particles within 1000 to 860 microns (20-18 mesh). Particles having useful sizes can be made through a variety of methods including, for example, by grinding, by micropelletization, by spray drying, by co-precipitation, and by other similar methods.

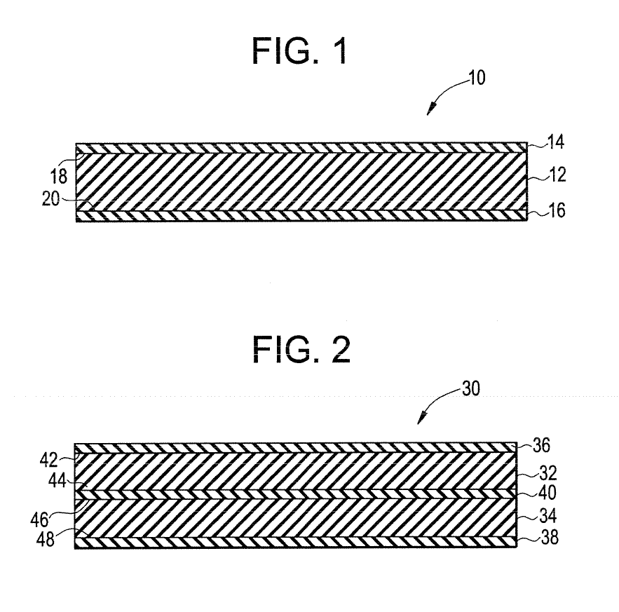

Referring to the drawings, FIG. 1 is a cross sectional illustration of an exemplary fiber reinforced thermoplastic composite sheet 10 that includes one porous core layer 12 and skins 14 and 16 laminated to outer surfaces 18 and 20 of core layer 12. In one embodiment, composite sheet 10 has a thickness of about 0.5 mm to about 50 mm and in another embodiment, a thickness of about 0.5 mm to about 25 mm. Also, skins 14 and 16 each have a thickness in one embodiment of about 25 micrometers to about 5 mm and in another embodiment from about 25 micrometers to about 2.5 mm.

Referring to FIG. 1, skins 14 and 16 are formed from materials that can withstand processing temperatures of 200° C. to 425° C. Skins 14 and 16 can be thermoplastic films, elastomeric films, poly(vinyl fluoride) films, metal foils, thermosetting coatings, inorganic coatings, fiber reinforced scrims, woven or non-woven fabric materials, and combinations of two or more of the foregoing materials. Any suitable thermoplastic material, including blends of thermoplastic materials, having a LOI greater than about 22, as measured in accordance with ISO 4589 test method, can be used for forming the thermoplastic films, including, for example, poly(ether imide), poly(arylene ether), poly(ether ketone), poly(ether-ether ketone), poly(phenylene sulfide), poly(ether sulfone), poly(amide imide), poly(aryl sulfone) and combinations of two or more of the foregoing thermoplastics. Suitable fibers for forming the scrims include, but are not limited to, glass fibers, aramid fibers, carbon fibers, inorganic fibers, metal fibers, metalized synthetic fibers, metalized inorganic fibers, and combinations of two of more of the foregoing fibers. In some embodiments, the fibers used in forming the scrims have a LOI greater than about 22, as measured in accordance with ISO 4589 test method.

The inorganic coating can include a layer of gypsum paste, calcium carbonate paste, mortar, concrete, and combinations of two or more of the foregoing inorganic materials. The fiber-based scrim can be a lightweight non-woven covering material manufactured via wet laid, air laid, spunbond, or spunlace processes. The fiber based scrim can comprise, for example, glass, carbon, a poly(vinyl fluoride), polyacrylonitrile, aramid, poly(p-phenylene-benzobisoxazole), poly(ether-imide), poly(phenylene sulfide) or a combination of two or more of the foregoing materials. The non-woven fabric can comprise a thermoplastic material, a thermal setting binder, inorganic fibers, metal fibers, metallized inorganic fibers and metallized synthetic fibers.

Skins 14 and 16 are laminated to porous core layer 12 by any suitable lamination process using heat and/or pressure with or without the use of an adhesive or a tie layer, for example using nip rollers or a lamination machine. Skins 14 and 16 are laminated to core 12 after it has been formed, and in one embodiment, skins 14 and 16 are laminated to core layer 12 before it has been cut into sheets of predetermined size. In some embodiments, skins 14 and 16 are laminated to core layer 12 after it has been cut into sheets. In some embodiments, the temperature of the lamination process is greater than the glass transition temperature of the thermoplastic material(s) of the skins, of the thermoplastic material(s) of the core layer, or the thermoplastic material(s) of the skins and core layer. In some embodiments, skins 14 and 16 are bonded to core layer 12 at room temperature using thermal setting adhesives and pressure.

FIG. 2 is a cross sectional illustration of another exemplary fiber reinforced thermoplastic sheet 30 that includes porous core layers 32 and 34, and skins 36, 38 and 40 laminated to porous core layers 32 and 34. Particularly, porous core layer 32 includes a first surface 42 and a second surface 44, and porous core layer 34 includes a first surface 46 and a second surface 48. Porous core layers 32 and 34 are arranged so that second surface 44 of core layer 32 is adjacent to first surface 46 of core layer 34. Skin 36 is positioned over first surface 42 of core layer 32, skin 38 is positioned over second surface 48 of core layer 34, and skin 40 is positioned between second surface 44 of core layer 32 and first surface 46 of core layer 34. Core layers 32 and 34, and skins 36, 38, and 40 are laminated together to form fiber reinforced thermoplastic sheet 30.

In an alternate embodiment, sheet 30 does not include skin 40 laminated between core layers 32 and 34. In further alternate embodiments, only one of the outer surfaces of sheet 30 includes a skin and/or a skin laminated between core layers 32 and 34. In a further alternate embodiment, sheet 30 includes a skin or a skin 40 laminated between core layers 32 and 34 that covers at least a part of second surface 44 of core layer 32 and first surface 46 of core layer 34.

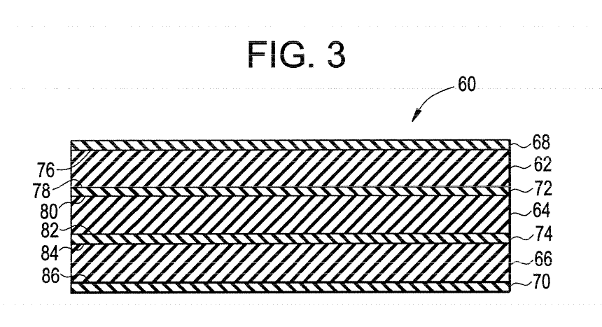

FIG. 3 is a cross sectional illustration of another exemplary fiber reinforced thermoplastic sheet 60 that includes porous core layers 62, 64, and 66, and skins 68, 70, 72, and 74 laminated to core layers 62, 64, and 66. Particularly, core layer 62 includes a first surface 76 and a second surface 78, core layer 64 includes a first surface 80 and a second surface 82, and core layer 66 includes a first surface 84 and a second surface 86. Core layers 62, 64, and 66 are arranged so that second surface 78 of core layer 62 is adjacent to first surface 80 of core layer 64, and second surface 82 of core layer 64 is adjacent to first surface 84 of core layer 66. Skin 68 is positioned over first surface 76 of core layer 62, skin 70 is positioned over second surface 86 of core layer 66, skin 72 is positioned between second surface 78 of core layer 62 and first surface 80 of core layer 64, and skin 74 is positioned between second surface 82 of core layer 64 and first surface 84 of core layer 66. Core layers 62, 64, and 66, and skins 68, 70, 72, and 74 are laminated together to form fiber reinforced thermoplastic sheet 60.

The porous fiber-reinforced thermoplastic composite sheets described above can be used in, but not limited to, building infrastructure, aircraft, train and naval vessel side wall panels, ceiling panels, cargo liners, office partitions, elevator shaft lining, ceiling tiles, recessed housing for light fixtures and other such applications that are currently made with honeycomb sandwich structures, thermoplastic sheets, and FRP. The composite sheets can be molded into various articles using methods known in the art including, for example, pressure forming, thermal forming, thermal stamping, vacuum forming, compression forming, and autoclaving. The combination of high stiffness to weight ratio, ability to be thermoformed with deep draw sections, end of life recyclability, acoustics and desirable low flame spread index, heat release, smoke density and gas emission properties make the porous fiber-reinforced thermoplastic composite a more desirable product than the products currently being used.

In some embodiments a skin layer has significantly permeability to air and gas flow. A spherical or particulate elastomeric or plastic material having an average particle size of 150 micrometers to 1.5 mm can be dispersed in the thermoplastic material. The spherical or particulate elastomeric or plastic material has a tan delta peak at a chosen frequency and temperature. The presence of tan delta peak at a particular frequency and specific temperature indicates the ability of the material to absorb and dissipate vibrational energy at that frequency and temperature, making the composite sheet useful for noise dampening and vibration damping applications.

The invention will be further described by reference to the following examples that are presented for the purpose of illustration only and are not intended to limit the scope of the invention. Unless otherwise indicated, all amounts are listed as parts by weight based on the total weight of the composition.

The measurement of dynamic viscosity at low shear (low-shear viscosity) is to be conducted in accordance with ASTM D4440-01 using a parallel-plate rheometer with a 2 cm plate, a 2 mm gap width, and flat plate geometry. A frequency sweep from 0.01 to 100 Hertz is conducted at a constant temperature in an air environment. The viscometer must have a controlled temperature chamber to maintain sample temperature to within 2 degrees of desired measurement temperature. In this case low-shear viscosity is used to denote the measurement of viscosity at or below a shear rate of 1.0 l/s. Shear rate is calculated from frequency using the following equation γ=ω*R/H where γ is the calculated shear rate, ω is the oscillation frequency, R is the plate radius in cm and H is the plate-plate separation in cm.

The following abbreviations are used to describe the materials.

| Abbreviation | Description |
|---|---|
| PPE-1 | Poly(arylene ether) having an intrinsic viscosity of 0.46 dl/g |
| | measured in chloroform at 25° C. |
| PPE-2 | Poly(arylene ether) having an intrinsic viscosity of 0.33 dl/g |
| | measured in chloroform at 25° C. |
| PPE-3 | Poly(arylene ether) having an intrinsic viscosity of 0.12 dl/g |
| | measured in chloroform at 25° C. |
| PPE-4 | PPE-2 reacted with 3 wt. % Polysalicylate |
| PPE-5 | PPE-3 reacted with 3 wt. % Polysalicylate |
| PPE-6 | PPE-2 reacted with 2 wt. % maleic anhydride |
| PPE-7 | PPE-2 reacted with 2 wt. % fumaric acid |
| PPE-8 | PPE-2 reacted with 2 wt. % citric acid |
| SEBS | Styrene-(ethylene-butylene)-styrene available under the |
| | tradename Kraton G 1651 from Kraton Polymers |
| XPS | Styrene homopolymer |
| HIPS | Rubber-modified polystyrene |
| Glass | Glass fiber an example of which is Owens Corning 122Y |
| HDPE | High density polyethylene |
| PP | Polypropylene |
| OCT | Trans-Polyoctenamer available under the trademark |
| | Vestenamer 8012 from Degussa |
| RDP | Resorcinol bis-diphenylphosphate |
| BPA-DP | Bis-phenol A bis-diphenylphosphate |
| PA6 | Polyamide-6 |
| PA66 | Polyamide-66 |
| PBT | Poly(1,4-butylene-terephthalate) |
| PET | Poly(1,2-ethylene-terephthalate) |
| BF-E | Ethylene - glycidyl methacrylate copolymer available |
| | from Sumitomo Chemicals under the trademark Bondfast E |
| PSAL | Polysalicylate |
| FA | Fumaric acid |
| BA | Boric acid |
| BA-S | Boric acid masterbatch of 30 weight percent boric acid in |
| | polystyrene |
| ZB | Zinc borate |
| MPP | Melamine polyphosphate |
| MEL | Melamine |
| MEL-C | Melamine cyanurate |
| MgO | Magnesium hydroxide - hydrate |
| FER | Ferrocene |
| SIL | Fumed silica |
| LMG | Low melting phosphate glass |
| DCP | Dicumyl peroxide |
| AMP | Ammonium polyhosphate |
| 1312 | A mixture of components comprising a phosphinate |
| | available commercially from Clariant corporation under |
| | the tradename Exolit OP 1312 |
| 1230 | A flame retardant comprising a phosphinate available |
| | commercially from Clariant corporation under the |
| | tradename Exolit OP 1230 |
| TPP | Triphenyl phosphate |
| BP | Boron phosphate |
| SF1706 | Amino siloxane fluid commercially available from |
| | Momentive Performance Materials under the tradename |
| | SF1706. |
| SF100 | Polydimethylsiloxane fluid containing MQ resin |
| | commercially available from Momentive Performance |
| | Materials under the tradename SF100. |
| CF2003 | Eugenol endapped D45 polysiloxane fluid available from |
| | Momentive Performance Materials under the tradename |
| | CF2003 |
| SFR100 | SFR100 is a silicone fluid FR from Momentive |
| | Performance materials |
| ZnO | Zinc oxide |
| ZnS | Zinc sulfide |
| Zn-ST | Zinc Stearate |
| Thio | An organic thioester sold under the tradename Seenox |
| | 412S |
| TDP | Tridecylphosphite |
| AO-1 | Anti-oxidant available from Ciba Geigy as Irganox 1010 |
| AO-2 | Anti-oxidant available from Ciba Geigy as Irgafos 168 |
| CCB | Electrically conductive carbon black commercially |
| | available from Akzo under the tradename Ketjen Black |
| | EC600JD. |

### EXAMPLES 1-6

The compositions shown in Table 1 were tested for low-shear viscosity. Results are shown below.

TABLE 1

| | Sample | | | | | |
|---|---|---|---|---|---|---|
| | 1* | 2* | 3 | 4 | 5 | 6 |
| PPE-1 | 95 | 90 | — | — | — | — |
| PPE-2 | — | — | 60 | 40 | 40 | 30 |
| PPE-3 | — | — | 20 | 10 | — | 20 |
| XPS | — | — | — | 40 | 40 | 30 |
| RDP | 5 | 10 | — | — | — | — |
| BPA-DP | — | — | 10 | 10 | 20 | 20 |
| Viscosity | 25000 | 30000 | 4700 | 6600 | 3100 | 1210 |
| (Pa-sec) | | | | | | |
| @ 260° C. | | | | | | |
| Viscosity | 6000 | 8000 | 1400 | 2100 | 950 | 110 |
| (Pa-sec) | | | | | | |
| @ 290° C. | | | | | | |
| Wet-out | N | N | Y | Y | Y | Y |
| @ 260° C. | | | | | | |
| Viscosity | N | N | Y | Y | Y | Y |
| (Pa-sec) | | | | | | |
| @ 290° C. | | | | | | |

*Comparative examples

The data in Table 1 illustrate various low-shear viscosities recorded at 0.1 Hz (1.0 l/s shear rate) at 260 and 290° C. for various poly(arylene ether) resin compositions. As seen with examples 1 and 2, the viscosities at 260° C. are quite high, in excess of 20,000 Pa-sec and at this temperature unacceptably poor wet out of the glass is observed. Increasing the temperature to 290° C., does result in significant decrease in the viscosity of Samples 1 and 2; however, even with the reduced viscosities, these samples unexpectedly show poor wet-out and processability of the glass. Additionally, these samples have significant amount of charring, presumably due to oxidation and cross-linking of the poly(arylene ether) and are unacceptable from a material performance perspective. Samples 3-6 unexpectedly demonstrated both significantly reduced low shear viscosities as well as very good processability and wet-out of the glass fiber.

The thermoplastic material of Examples 3-6 was ground to a powder material (having a maximum particle size less than 1 mm). A 10 g sample of each material was placed in an aluminum dish (diameter 6±0.5 cm, depth 2±0.2 cm metal thickness less than 1±0.5 mm). An air convection oven was pre-heated and maintained 300° C. The sample was placed in the oven and kept there for 10 minutes in this case. The sample was then removed from the oven and allowed to cool to room temperature. The sample was then evaluated using two criteria: (1) degree of melting and (2) the molecular weight increase after exposure with respect to the initial molecular weight. Criteria (1): The sample was considered to pass this criterion if the cooled sample showed no surface irregularities or particulate nature after cooling to room temperature. If there was any discernable particulate or powder nature to the sample, it was considered to fail. The surface of the sample after cooling should be smooth and continuous. The samples were rated as Not Melted, Partially Melted, or Fully Melted, respectively. Color change was also noted before and after. Criteria (2): The weight-averaged molecular weight as determined by gel-permeation chromatography was measured for a representative sample of the exposed samples and the corresponding material before treatment.

TABLE 2

| | | Initial | Final | Percent | Visual |
|---|---|---|---|---|---|
| Example | Color | Mw | Mw | Increase | Description |
| 3 | amber | 34,798 | 40,961 | 18% | Fully Melted |
| 4 | amber | 37,094 | 38,764 | 5% | Fully Melted |
| 5 | yellow | 42,846 | 40,149 | −6% | Fully Melted |
| 6 | light amber | 29,257 | 29,669 | 1% | Fully Melted |

Table 2 illustrates the unexpected results obtained with the compositions of Examples 3 to 6 in a simulated test for the manufacture of the composite sheets at 300° C. for 10 minutes. The initial molecular weight of the poly(arylene ether) was determined and compared to the molecular weight after the thermal history. These compositions were fully melted at this temperature and had acceptable levels of cross-linking as indicated by the relatively low level of increased molecular weight. This is in sharp contrast to the results obtained for samples 1 and 2 as explained above during viscosity measurement testing even at lower temperatures.

The thermoplastic materials of Examples 3-6 were successfully used in making composite sheets using glass fibers. Despite the coloration shown in melt behavior testing the composite sheets did not discolor. The composite sheets showed excellent flame spread and smoke density testing.

### EXAMPLES 7-12

Thermoplastic materials having the composition shown in Table 3 were tested for melt behavior as described above with regard to Examples 3-6. Compositions were made by melt blending the poly(arylene ether) with the fumaric acid followed by further melt blending with the polyamide. The results are shown in Table 3.

TABLE 3

| | Sample | | | | | |
|---|---|---|---|---|---|---|
| | 7 | 8 | 9 | 10 | 11 | 12 |
| PPE-2 | 69 | 54 | 59 | 59 | 49 | 44 |
| PPE-3 | — | — | 10 | 20 | 20 | 20 |
| FA | 1 | 1 | 1 | 1 | 1 | 1 |
| PA6 | 10 | 25 | 10 | 10 | 10 | 25 |
| BPA-DP | 20 | 20 | 20 | 10 | 20 | 10 |
| Color | Lt. | Lt. | Lt. | Red/ | Red/ | Red/ |
| | Caramel | Caramel | Caramel | Brown | Brown | Brown |
| Visual | Fully | Fully | Fully | Fully | Fully | Fully |
| Description | Melted | Melted | Melted | Melted | Melted | Melted |

The blended resins contained in the following tables can be dispersed in a porous fiber-reinforced sheet containing about 40 weight percent glass fibers having an average fiber diameter of 16 micrometers and an average length of 12.7 mm. The fiber-reinforced thermoplastic sheets can be made using the wet-laid paper making process described in United Kingdom Patent Nos. 1129757 and 1329409. The fiber-reinforced thermoplastic sheet can be further subjected to heat and pressure in a double belt laminator at an elevated temperature, e.g., 230-340° C. and pressure, e.g., 1-10 bar, to partially consolidate the sheet and have the resin wet the fibers.

The flame characteristics may be measured using a radiant heat source and an inclined specimen of the sample material in accordance with ASTM method E-162-02A titled Standard Method for Surface Flammability of Materials Using a Radiant Heat Energy Source. A flame spread index may be derived from the rate of progress of the flame front and the rate of heat liberation by the material under test. Key criteria are a flame spread index (FSI) and dripping burning dripping observations. United States and Canadian requirements for passenger bus applications for interior materials are a FSI of 35 or less with no flaming drips. The Underwriters Laboratory (UL) requires that parts greater than 10 square feet should have an FSI of 200 or less to obtain a listing from UL.

The smoke characteristics may be measured by exposing test specimens to flaming and non flaming conditions within a closed chamber according to ASTM method E-662-03 titled Standard Test Method for Specific Optical Density of Smoke Generated by Solid Materials. Light transmissions measurements may be made and used to calculate specific optical density of the smoke generated during the test time period. Key criteria are an optical density (Dₛ) of smoke produced by a sample exposed to a radiant furnace or a radiant furnace plus multiple flames. The optical density may be plotted versus time for generally 20 minutes. Maximum optical density and time to reach this maximum are important outputs. United States and Canadian Rail regulations and some United States and Canadian Bus guidelines set a maximum Dₛ of 100 or less at 1.5 minutes, and a maximum Dₛ of 200 or less at 4 minutes. Global air regulations sets the Dₛ at 4 minutes for many large interior applications at 200 or less.

FAA requirements for toxicity and flame may be measured in accordance FAA tests BSS-7239, developed by Boeing Corporation., and FAR 25.853 (a) Appendix F, Part IV (OSU 65/65) Calorimeter.

A large part in an aircraft passenger cabin interior typically will need to meet the ASTM E162 and ASTM E662 described above as well a maximum Ds of 200 at 4 minutes. A difficult test for plastics has traditionally been the OSU 65/65 heat release test. In this test, the test material is exposed to defined radiant heat source, and calorimeter measurements are recorded. Key criteria are an average maximum heat release during the 5 minute test that should not exceed 65 kW/m², and an average total heat released during the first 2 minutes of the test that should not exceed 65 kW-min/m².

In the 60 second vertical burn test, the part is exposed to a small-scale open flame for 60 seconds and the key criteria are a burned length of 150 mm or less, an after flame time of 15 seconds or less, and flame time drippings of 3 seconds or less.

TABLE 4

| | Sample | | | | | | |
|---|---|---|---|---|---|---|---|
| | 13 | 14 | 15 | 16 | 17 | 18 | 19 |
| PPE-1 | 80 | 65 | 80 | 80 | — | — | 20 |
| PPE-2 | — | — | — | — | 80 | 70 | 50 |
| PPE-3 | 10 | 25 | 10 | 10 | 10 | 20 | 20 |
| XPS | — | — | — | 10 | — | — | — |
| RDP | 10 | 10 | — | — | 10 | 10 | 10 |
| BPA-DP | — | — | 10 | 10 | — | — | — |

The compositions in Table 4 illustrate that a wide variety of combinations of poly(arylene ether) having different molecular weights wherein at least 10% by weight of the composition contains a poly(arylene ether) having an intrinsic viscosity of 0.33 dl/g or less, are useful in the composite sheet materials.

TABLE 5

| | Sample | | | | | | |
|---|---|---|---|---|---|---|---|
| | 20 | 21 | 22 | 23 | 24 | 25 | 26 |
| PPE-1 | 50 | 50 | 50 | — | — | — | 20 |
| PPE-2 | — | — | — | 50 | 40 | 40 | 20 |
| PPE-3 | — | 10 | — | — | 10 | 10 | 10 |
| RDP | 10 | 10 | — | 10 | — | 10 | 5 |
| BPA-DP | — | — | 10 | — | 10 | — | — |
| TPP | — | — | — | — | — | — | 5 |
| XPS | 40 | 30 | — | 40 | 40 | — | 40 |
| HIPS | — | — | 40 | — | — | 40 | — |

The compositions in Table 5 illustrate that a wide variety of combinations of poly(arylene ether) molecular weights and various polystyrene polymers are useful in the composite sheet materials.

TABLE 6

| | Sample | | | | | | |
|---|---|---|---|---|---|---|---|
| | 27 | 28 | 29 | 30 | 31 | 32 | 33 |
| PPE-3 | — | — | — | — | 20 | — | — |
| PPE-4 | 90 | 80 | 60 | 75 | 75 | 70 | 65 |
| PPE-5 | — | 10 | 10 | 20 | — | — | — |
| XPS | — | — | 20 | — | — | 20 | 20 |
| RDP | 10 | — | 10 | — | — | 5 | — |
| BPA-DP | — | 10 | — | — | — | — | 10 |
| BA | — | — | — | 2 | — | — | — |
| BA-S | — | — | — | — | 5 | 5 | 5 |
| CCB | — | — | — | — | — | 2 | — |

The compositions in Table 6 illustrate that a capped poly(arylene ether) resins, alone and in combination with polystyrene polymers are useful in the composite sheet materials. Additionally, boric acid can be a useful additive for reduced smoke emissions.

TABLE 7

| | Sample | | | | | | |
|---|---|---|---|---|---|---|---|
| | 34 | 35 | 36 | 37 | 38 | 39 | 40 |
| PPE-2 | 70 | 65 | — | 70 | 60 | — | 60 |
| PPE-3 | 10 | 15 | — | 10 | 10 | — | 15 |
| PPE-4 | — | — | 70 | — | — | 72 | — |
| PPE-5 | — | — | 15 | — | — | 10 | — |
| XPS | 10 | 10 | — | 10 | 10 | — | — |
| RDP | 10 | — | 10 | 10 | 10 | 10 | — |
| BPA-DP | — | 10 | — | — | — | — | 10 |
| PSAL | — | 5 | — | 4 | — | — | 5 |
| BA-S | — | — | 5 | — | — | — | — |
| TDP | 0.5 | 2 | 1 | 0.5 | — | — | — |
| ZnO | 0.5 | 0.2 | 0.3 | — | — | — | — |
| ZnS | 0.5 | 0.2 | 0.3 | — | — | — | — |
| Thio | — | 0.5 | 0.8 | — | — | — | — |
| SF100 | — | — | — | 2 | — | — | — |
| SIL | — | — | — | — | 5 | 5 | 5 |
| CF2003 | — | — | — | — | 5 | 3 | 4 |
| DCP | — | — | — | — | 1 | 0.8 | 1 |

The compositions in Table 7 illustrate various other poly(arylene ether) containing compositions that are useful in composite sheets. Examples 28-30 demonstrate various alternatives used to reduce oxidation of the poly(arylene ether) during the preparation of the composite sheet. Examples 31-34 offer various options for generation of lower smoke and enhanced flame retardance with various silicone based additives.

TABLE 8

| | Sample | | | | | | |
|---|---|---|---|---|---|---|---|
| | 41 | 42 | 43 | 44 | 45 | 46 | 47 |
| PPE-2 | 70 | 70 | — | 60 | 60 | — | 60 |
| PPE-3 | 15 | — | — | 10 | 10 | — | 10 |
| PPE-4 | — | — | 70 | — | — | 70 | — |
| PPE-5 | — | — | — | — | — | — | — |
| XPS | — | 15 | 15 | 15 | 20 | 15 | 10 |
| RDP | 10 | 10 | — | 10 | — | — | 10 |
| BPA-DP | — | — | 10 | — | — | — | — |
| PSAL | — | — | — | 5 | — | — | 5 |
| TDP | — | — | — | — | 5 | 10 | — |
| BA-S | — | — | — | — | 5 | 5 | — |
| AMP | — | — | — | — | — | — | 5 |
| MPP | 5 | — | — | — | — | — | — |
| 1312 | — | 5 | — | — | — | — | — |
| 1230 | — | — | 5 | — | — | — | — |
| CCB | — | — | — | — | 2 | 3 | — |

The compositions in Table 8 illustrate various other poly(arylene ether) containing compositions that are useful in composite sheets.

TABLE 9

| | Sample | | | | | | |
|---|---|---|---|---|---|---|---|
| | 48 | 49 | 50 | 51 | 52 | 53 | 54 |
| PPE-3 | — | 10 | 10 | — | — | 10 | 5 |
| PPE-6 | 50 | 35 | 40 | — | — | — | — |
| PPE-7 | — | — | — | 40 | 35 | 65 | 45 |
| PA6 | 50 | — | 10 | — | — | — | 35 |
| PA66 | — | 40 | 40 | 30 | 50 | 15 | — |
| SF1706 | 3 | — | 3 | — | — | — | — |
| BPA-DP | — | — | 10 | — | — | — | — |
| PSAL | — | — | — | 5 | — | 3 | — |
| BP | — | 5 | 3 | 3 | 5 | — | 5 |
| MEL | — | — | — | — | 10 | — | — |
| MEL-C | — | — | — | — | — | 5 | — |
| AMP | — | — | — | — | — | — | 10 |
| MPP | — | — | — | — | — | 5 | — |
| 1312 | — | — | — | 10 | — | — | — |
| 1230 | — | 10 | — | — | — | — | — |
| CCB | — | — | — | — | — | — | 2 |

The compositions in Table 9 illustrate various compositions containing poly(arylene ether) and polyamide resin that are useful in composite. Additionally, compositions of poly(arylene ether) that contain polyamide resins, e.g., PA-6 and PA-6,6 in relatively minor proportions such as 5-20 parts by weight per 100 parts of total resin, will show improved flow characteristics that allow for processing into composite sheet materials more like semicrystalline resins than amorphous resins giving better wet-out of the glass fibers. Additionally, the composite sheet maintained flame retardant properties that are more characteristic of amorphous materials.

TABLE 10

| | Sample | | | | | | |
|---|---|---|---|---|---|---|---|
| | 55 | 56 | 57 | 58 | 59 | 60 | 61 |
| PPE-1 | 40 | — | 35 | — | — | — | — |
| PPE-2 | — | 45 | — | 30 | — | 60 | 35 |
| PPE-3 | — | — | 10 | 10 | — | 10 | 15 |
| PPE-4 | — | — | — | — | 45 | — | — |
| PP | 40 | — | 35 | — | 30 | 10 | 15 |
| HDPE | — | 35 | — | 40 | — | — | 15 |
| SEBS | 5 | 2 | 4 | 5 | 5 | 2 | 3 |
| BPA-DP | 10 | — | — | — | — | 8 | 10 |
| PSAL | — | 3 | — | 5 | — | — | — |
| ZB | — | — | 5 | 2 | — | — | — |
| SF100 | 2 | — | — | 8 | 5 | 10 | 7 |
| MgO | — | 5 | — | — | — | — | — |
| AMP | 2 | — | 5 | — | 5 | — | — |
| MPP | — | 5 | — | — | 5 | — | — |
| MEL | — | — | 5 | — | — | — | — |
| MEL-C | — | 5 | — | — | 5 | — | — |

The compositions in Table 10 illustrate various compositions containing poly(arylene ether) and polyolefin resin that are useful in the composite sheet materials.

TABLE 11

| | Sample | | | | | | | |
|---|---|---|---|---|---|---|---|---|
| | 62 | 63 | 64 | 65 | 66 | 67 | 68 | 69 |
| PPE-2 | — | 40 | — | — | 55 | 45 | 55 | — |
| PPE-3 | — | — | — | — | — | 15 | 10 | 10 |
| PPE-7 | — | — | 40 | — | — | — | — | — |
| PPE-8 | 39 | — | — | 40 | — | — | — | 45 |
| PBT | 40 | — | 10 | 42 | 30 | 25 | — | — |
| PET | — | 35 | 30 | — | — | — | 20 | 25 |
| BF-E | 3 | 5 | 8 | 3 | — | — | 3 | — |
| BPA-DP | 10 | — | — | — | — | — | — | — |
| RDP | — | 10 | 7 | — | — | — | — | — |
| SEBS | 3 | — | — | — | — | — | — | 5 |
| BA-S | — | 5 | — | — | — | — | — | — |
| 1312 | — | — | — | 15 | — | 15 | — | 15 |
| 1230 | — | — | — | — | 15 | — | 12 | — |
| SF100 | 5 | 2 | — | — | — | — | — | — |
| AO-1 | 0.3 | 0.2 | — | 0.3 | 0.3 | 0.2 | 0.3 | 0.3 |
| AO-2 | 0.3 | 0.2 | — | 0.2 | 0.3 | 0.4 | 0.3 | 0.3 |
| MEL-C | — | — | 5 | — | — | — | — | — |

The compositions in Table 11 illustrate that a wide variety of combinations of poly(arylene ether) molecular weights and various polystyrene polymers are useful in the composite sheet materials.

TABLE 12

Sample

| | 70 | 71 | 72 | 73 | 74 | 75 |
|---|---|---|---|---|---|---|
| PPE-2 | 69 | 54 | 59 | 59 | 49 | 44 |
| PPE-3 | — | — | 10 | 20 | 20 | 20 |
| FA | 1 | 1 | 1 | 1 | 1 | 1 |
| PA6 | 10 | 25 | 10 | 10 | 10 | 25 |
| BPA-DP | 20 | 20 | 20 | 10 | 20 | 10 |

The compositions in Table 12 illustrate that a wide variety of combinations of poly(arylene ether) molecular weights and PA-6 are useful in the composite sheet materials.

TABLE 13

| | Sample | | | | | | | | | | |
|---|---|---|---|---|---|---|---|---|---|---|---|
| | 76 | 77 | 78 | 79 | 80 | 81 | 82 | 83 | 84 | 85 | 86 |
| PPE-2 | 49 | 44 | 69 | 49 | 49 | 49 | 69 | 69 | 69 | 49 | 69 |
| PPE-3 | 20 | 20 | 20 | 20 | 20 | 20 | 20 | 20 | 20 | 20 | 20 |
| FA | 1 | 1 | 1 | 1 | 1 | 1 | 1 | 1 | 1 | 1 | 1 |
| PA6 | 10 | 25 | — | 10 | 10 | 10 | — | — | — | 10 | — |
| BPA-DP | 10 | 15 | 10 | 10 | 10 | 10 | 10 | 10 | 10 | 10 | 10 |
| BA-S | — | — | — | 5 | — | — | 5 | — | — | 5 | 5 |
| MEL | — | — | — | — | 5 | — | — | 5 | — | 5 | 5 |
| SF1706 | — | — | — | — | — | 5 | — | — | 5 | 5 | 5 |

The compositions in Table 13 illustrate that additional combinations of poly(arylene ether) molecular weights and PA-6 are useful in the composite sheet materials.

TABLE 14

| | Sample | | | | | | | | | | |
|---|---|---|---|---|---|---|---|---|---|---|---|
| | 87 | 88 | 89 | 90 | 91 | 92 | 93 | 94 | 95 | 96 | 97 |
| PPE-2 | 60 | 60 | 60 | 60 | 60 | 60 | 60 | 60 | 60 | 60 | 60 |
| PPE-3 | 20 | 20 | 20 | 20 | 20 | 20 | 20 | 20 | 20 | 20 | 20 |
| XPS | 10 | 10 | 10 | 10 | 10 | 10 | 10 | 10 | 10 | 10 | 10 |
| SF1706 | — | — | 4 | — | — | — | 4 | — | — | — | 4 |
| BA-S | — | 4 | 4 | 4 | 4 | 5 | — | — | — | — | 4 |
| ZB | — | — | — | — | — | 4 | 5 | — | — | — | — |
| AMP | — | — | — | — | — | — | — | — | 5 | — | 5 |
| Melamine borate | — | — | — | — | 4 | — | — | 5 | — | 5 | 5 |
| MEL | — | — | — | — | — | — | — | — | 5 | — | — |
| Zn-ST | — | — | — | — | — | — | — | 10 | — | — | — |
| SF100 | — | — | — | — | — | — | — | 10 | — | — | — |
| PSAL | — | — | — | 5 | 5 | — | — | — | — | — | 5 |
| CF2003 | 5 | 5 | 5 | 5 | 5 | — | — | — | — | — | — |
| SIL | 5 | 5 | 5 | 5 | 5 | — | — | — | — | — | — |
| DCP | 1 | 1 | 1 | 1 | 1 | — | — | — | — | — | — |
| FER | — | — | — | — | — | — | — | — | — | 5 | — |
| LMG | — | — | — | — | — | 10 | — | — | — | — | — |
| BPA-DP | 10 | 10 | 10 | 10 | 10 | 10 | 10 | 10 | 10 | 10 | 10 |

The compositions in Table 14 illustrate that additional combinations of poly(arylene ether) molecular weights with various additives are useful in the composite sheet materials.

TABLE 15

| | Sample | | | | | | | | | | | | |
|---|---|---|---|---|---|---|---|---|---|---|---|---|---|
| | 98 | 99 | 100 | 101 | 102 | 103 | 104 | 105 | 106 | 107 | 108 | 109 | 110 |
| PPE-1 | 40 | 40 | 40 | 40 | 40 | 40 | 40 | 40 | 40 | 40 | 40 | — | — |
| PPE-2 | — | — | — | — | — | — | — | — | — | — | — | 75 | 50 |
| PPE-3 | — | — | — | — | — | — | — | — | — | — | — | — | 20 |
| PSAL | — | — | — | — | — | — | — | — | — | — | — | — | 5 |
| OCT | — | — | — | — | — | — | — | — | — | — | — | 5 | 5 |
| BA-S | — | — | — | — | — | — | — | — | — | — | — | 5 | 5 |
| PP | 40 | 40 | 40 | 40 | 40 | 40 | 40 | 40 | 40 | 40 | 40 | — | — |
| SF1706 | — | — | — | — | — | — | — | — | — | — | — | — | — |
| RDP | — | — | — | — | — | — | — | — | — | — | — | 15 | 15 |
| SEBS | 10 | 10 | 10 | 10 | 10 | 10 | 10 | 10 | 10 | 10 | 10 | — | — |
| ZB | — | — | — | 5 | — | 4 | 5 | — | — | — | — | — | — |
| Melamine borate | 10 | — | — | 5 | 4 | — | — | 5 | — | 5 | 5 | — | — |
| MEL | — | — | — | — | — | — | — | — | 5 | — | — | — | — |
| Zn-ST | | — | — | — | — | 10 | — | 10 | — | — | — | — | — |
| SFR100 | — | — | — | — | — | 10 | — | 10 | — | — | — | — | — |
| MEL-C | 2 | — | 5 | — | — | — | — | — | — | — | — | — | — |
| MPP | — | 5 | 5 | 5 | — | — | — | — | — | — | — | — | — |
| MgO | — | 5 | 5 | 5 | — | — | — | — | — | — | — | — | — |
| AMP | 2 | — | — | 5 | — | — | — | — | 5 | — | 5 | — | — |
| FER | — | — | — | — | 5 | — | — | — | — | 5 | — | — | — |
| LMG | — | — | — | — | — | 10 | — | — | — | — | — | — | — |
| BPA-DP | 15 | 15 | 5 | 15 | 15 | 15 | 15 | 15 | 15 | 15 | 15 | — | — |

The compositions in Table 15 illustrate additional combinations of poly(arylene ether) and polypropylene with various additives are useful in the composite sheet materials.

Various embodiments of the present invention result in composite sheet material with a smoke density of less that 100 after 1.5 minutes and less than 200 after 4 minutes under the ASTM 662 conditions.

While the invention has been described in terms of various specific embodiments, those skilled in the art will recognize that the invention can be practiced with modification within the spirit and scope of the claims.

1. A composite sheet material comprising:
a porous core layer adjacent to skin layer,
wherein the porous core layer comprises a thermoplastic material and 20 to 80 weight percent fibers based on a total weight of the porous core layer,
wherein the thermoplastic material comprises poly(arylene ether) and an additive comprising a flame retardant, smoke emission retardant, a flame and smoke emission retardant or a combination of two or more of the foregoing retardants,
wherein the additive is free of chlorine and bromine,
wherein the thermoplastic material has a low-shear viscosity of less than 6,000 Pa-sec at 290° C., when measured using ASTM 4440 with plate diameter of 2 centimeters and gap width of 2 millimeters at 1.0 l/s frequency and flat plate geometry and wherein the skin layer covers at least a portion of a surface of the porous core layer.

2. (canceled)

3. The composite sheet of claim 1, wherein the thermoplastic material has a low shear viscosity of less than or equal to 5,000 Pa-sec at 290° C., when measured using ASTM 4440 with plate diameter of 2 centimeters and gap width of 2 millimeters at 1.0 l/s frequency and flat plate geometry.

4. The composite sheet of claim 1, wherein the thermoplastic material has a low shear viscosity of less than or equal to 4,000 Pa-sec at 290° C., when measured using ASTM 4440 with plate diameter of 2 centimeters and gap width of 2 millimeters at 1.0 l/s frequency and flat plate geometry.

5. The composite sheet of claim 1, wherein the skin comprises a thermoplastic film, a poly(vinyl fluoride) film, an elastomeric film, a metal foil, a thermosetting coating, an inorganic covering, a fiber based scrim, a non-woven fabric, a woven fabric or a combination of two or more of the foregoing materials.

6. The composite sheet of claim 1 wherein the skin has a limiting oxygen index greater than 22, as measured per ISO 4589.

7. The composite sheet of claim 1, wherein the thermoplastic material further comprises a viscosity modifier.

8. The composite sheet of claim 7, wherein the viscosity modifier comprises an alkenyl aromatic polymer, a polyamide, a polyester, a polyolefin, or a combination of two or more of the foregoing viscosity modifiers.

9. The composite sheet of claim 1, wherein the poly(arylene ether) has an initial weight average molecular weight and a final weight average molecular weight after being exposed to 300° C. for 10 minutes and the ratio of the final molecular weight to the initial molecular weight is less than or equal to 0.5.

10. The composite sheet of claim 1, wherein the poly(arylene ether is a capped poly(arylene ether).

11. The composite sheet material of claim 1, wherein the additive is selected from the group consisting of boric acid, zinc borate, phosphinates, melamine, melamine cyanurate, melamine phosphate, melamine pyrophosphate, melamine polyphosphate, melam, melem, melon, boron phosphate, red phosphorous, organophosphate esters, polyorganosiloxanes, polyorganosiloxanes having a constituent capable of reacting with a carboxyl group, polyorganosiloxanes having a constituent capable of reacting with an amine group, monoammonium phosphate, diammonium phosphate, alkyl phosphonates, metal dialkyl phosphinate, ammonium polyphosphates, low melting glasses, melamine borate, and a combination containing two or more of the foregoing.

12. The composite sheet of claim 1, wherein the thermoplastic material comprises polyamide and wherein the additive comprises melamine borate, ammonium phosphate, polyorganosiloxane having an amine group, organophosphate ester, or a combination of two or more of the foregoing additives.

13. The composite sheet of claim 1, wherein the thermoplastic material comprises polyolefin and wherein the additive comprises boric acid, melamine cyanurate, melamine borate, ammonium phosphate, organophosphate ester, polyorganosiloxane having an amine group or a combination of two or more of the foregoing additives.

14. The composite sheet of claim 1, wherein thermoplastic material comprises greater than or equal to 50 percent by weight, based on the total weight of the thermoplastic material, of poly(arylene ether) and wherein the additive comprises boric acid, zinc borate, melamine borate, ammonium phosphate, organophosphate ester, polyorganosiloxane having an amine group, or a combination of two or more of the foregoing additives.

15. The composite sheet of claim 1, wherein the poly(arylene ether) comprises a salicylate capped poly(arylene ether).

16. The composite sheet of claim 1, wherein the thermoplastic material comprises polystyrene and wherein the additive comprises an organophosphate ester, boric acid, a polyorganosiloxane having an amine group, zinc borate, melamine borate, ammonium phosphate, or a combination of two or more of the foregoing additives.

17. The composite sheet of claim 1, wherein the flame and smoke emission retardant contains less than 1,000 parts by weight of total chlorine and bromine per million parts by weight of the thermoplastic material.

18. The composite sheet of claim 1, wherein the composite sheet has a four minute smoke density, Ds, of less than or equal to 200 when tested in accordance with ASTM E662.

19. The composite sheet of claim 1, wherein the composite sheet has a four minute smoke density, Ds, of less than or equal to 100 when tested in accordance with ASTM E662.

20. The composite sheet of claim 1, wherein the composite sheet has a four minute smoke density, Ds, of less than or equal to 50 when tested in accordance with ASTM E662.

21. The composite sheet of claim 1, wherein the poly(arylene ether) comprises a first poly(arylene ether) and a second poly(arylene ether) wherein the first poly(arylene ether) has an initial intrinsic viscosity of greater than or equal to 0.30 dl/g and the second poly(arylene ether) has an initial intrinsic viscosity less than less than or equal to 0.25 dl/g.

22. The composite sheet of claim 1, wherein the composite sheet is electrically conductive.

23. The composite sheet of claim 1, wherein the composite sheet comprises optical fiber.

24. The composite sheet of claim 1, wherein thermoplastic material comprises a spherical or particulate elastomeric or plastic material.

25. A composite sheet material comprising:
a porous core layer having a surface; and
a skin layer adjacent to and in physical contact with at least a portion of the surface of the porous core layer,
wherein the porous core layer comprises discontinuous fibers bonded together with a thermoplastic material comprising poly(arylene ether), wherein the thermoplastic material has a low-shear viscosity of less than 6,000 Pa-sec at 290° C., when measured using ASTM 4440 with plate diameter of 2 centimeters and gap width of 2 millimeters at 1.0 l/s frequency and flat plate geometry,
wherein the porous core has a density of 0.2 grams per cubic centimeter (gm/cm³) to 1.5 gm/cm³, and
the skin layer consists of a material having a limiting oxygen index greater than about 22, as measured in accordance with ISO 4589.
